(19) United States
(12) Patent Application Publication
(10) Pub. No.: US 2002/0028700 A1
(43) Pub. Date: Mar. 7, 2002

(54) Power control method in wireless communication device

(76) Inventor: Haruhisa Kato, Tokyo (JP)

Correspondence Address: FITZPATRICK CELLA HARPER & SCINTO, 30 ROCKEFELLER PLAZA, NEW YORK, NY, 10112, US

(21) Appl. No.: 09/925,745

(22) Filed: Aug. 10, 2001

(30) Foreign Application Priority Data
Aug. 24, 2000 (JP) 253983/2000

(51) Int. Cl. H04M 1/00

(52) U.S. Cl. 455/572; 455/574; 455/343

(57) ABSTRACT

A series regulator and a DC/DC converter stabilize an output voltage of a battery to supply a stabilized voltage to a wireless communication device. The wireless communication device stops the DC/DC converter while a transmission is not permitted and drives the DC/DC converter at the time of transmission. The wireless communication device does not drive the DC/DC converter when a transmission output is low, and drives the DC/DC converter when the transmission output is high.

### BACKGROUND OF THE INVENTION

1. Field of the Invention

The present invention relates to a power control method in a wireless communication device.

2. Related Background Art

There has been provided a system that image information outputted from an image information device such as a DVD player or a digital camera is transmitted to a printer through a wireless network to output an image. In this system, a network connection state based on a communication protocol is set between the image information device and the printer, so that the transfer of the image information is realized.

Now then, in a wireless communication part included in the image information device, a power load when the image information is transmitted is normally larger than that when the image information is received. Therefore, a power circuit is designed to meet the power load when the image information is transmitted. When a battery is used as a power source of the image information device, a voltage stabilizing circuit is provided so as to meet the variation of the output voltage of the battery.

Further, when the image information device transfers the image information to the printer through the wireless network, the image information device does not continuously transmit the image information to the wireless network, but divides the image information into a plurality of packets and transmits the packets to the wireless network. In the case where many devices are connected to the wireless network, a communication time allocated to each device may be frequently limited to several %. Therefore, in most of cases, the rate of time required for transmitting the information in the wireless communication part included in the image information device is merely insignificant.

Regardless of the above described circumstances, the power circuit of a wireless communication is designed to meet the power load at the time of transmitting the image information. Specially, when the battery is employed as a power source of the image information device and the voltage stabilizing circuit is provided, a consumed power in the stabilizing circuit causes a trouble.

That is, since the power circuit is designed to meet the power load when the image information is transmitted, the voltage stabilizing circuit is also designed to meet the power load upon transmission of the image information. In the voltage stabilizing circuit designed so as to meet a large power load, the consumed power in the voltage stabilizing circuit is larger than that of a voltage stabilizing circuit designed so as to meet a small power load, and the consumed power in the voltage stabilizing circuit is rarely changed relative to the fluctuation of the power load.

Accordingly, even during the receiving operation of the image information, which occupies most of operating time in the wireless communication part, a large power consumption equivalent to that during the transmission of the image information is disadvantageously required in the voltage stabilizing circuit.

### SUMMARY OF THE INVENTION

The present invention is proposed by considering the above described problems and it is an object of the present invention to provide a wireless communication device and a power control method in which a power consumption in the power circuit of a wireless communication part is reduced.

### BRIEF DESCRIPTION OF THE DRAWINGS

FIG. 1 is a block diagram showing a configuration of a first embodiment of a power circuit in a wireless communication device included in an image information device according to the present invention;

FIG. 2 is a flowchart of the first embodiment;

FIGS. 3A, 3B and 3C are timing charts showing a transmission timing of a transmission permission packet and a transmission packet and the operating timing of a DC/DC converter in the first embodiment;

FIGS. 4A, 4B and 4C are timing charts showing the transmission timing of a transmission permission packet and a transmission packet and the operating timing of a DC/DC converter in a second embodiment;

FIG. 5 is a flowchart of the second embodiment;

FIG. 6 is a flowchart of the second embodiment;

FIG. 7 is a block diagram showing a configuration of a third embodiment of a power circuit in the wireless communication device included in the image information device of the present invention;

FIG. 8 is a block diagram showing a configuration of a transmission output switch circuit; and

FIG. 9 is a block diagram showing a configuration of a fourth embodiment of a power circuit in the wireless communication device.

### DETAILED DESCRIPTION OF THE PREFERRED EMBODIMENTS

Now, there will be described embodiments of the present invention by referring to the accompanying drawings.

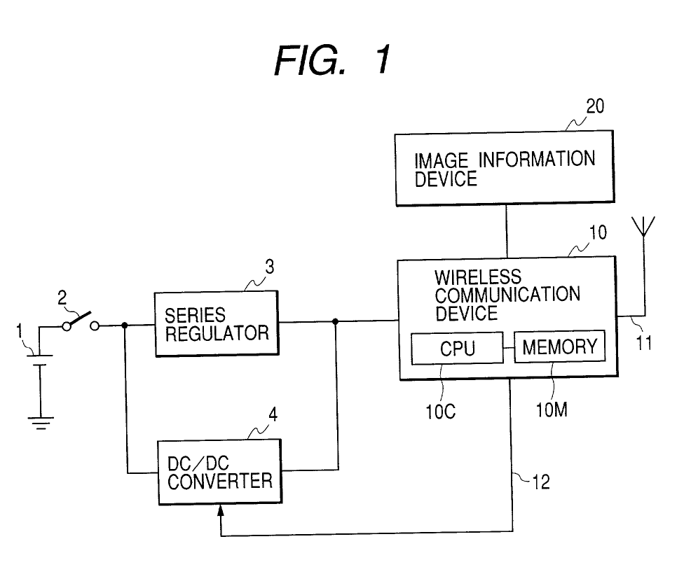

FIG. 1 is a block diagram showing a configuration of a first embodiment of a power circuit in a wireless communication device included in an image information device according to the present invention.

In FIG. 1, reference numeral 1 designates a battery. 2 designates a power switch for switching on and off the supply of power to a wireless communication device 10 from the battery 1. 3 denotes a series regulator and 4 denotes a DC/DC converter.

The series regulator 3 and the DC/DC converter 4 respectively stabilize the supply voltage of the battery 1 to supply the stabilized voltage to the wire communication device 10. When the series regulator 3 is compared with the DC/DC converter 4, the current supply capacity of the series regulator 3 is low and that of the DC/DC converter 4 is high.

A state signal showing the transmission state of the wireless communication device 10 is transmitted to the DC/DC converter 4 from the wireless communication device 10 through a signal line 12. This state signal is a signal which reaches a high level only when the wireless communication device 10 is brought to a transmission state.

The DC/DC converter 4 operates when the state signal is located at the high level to output stabilizing voltage to the wireless communication device 10. However, when the state signal is located at a low level, the DC/DC converter 4 does not operate to output no stabilizing voltage to the wireless communication device.

Therefore, when the wireless communication device 10 is located in a receiving state and the state signal of a low level is generated, any power is not consumed in the DC/DC converter 4.

Reference numeral 11 denotes an antenna connected to the wireless communication device 10.

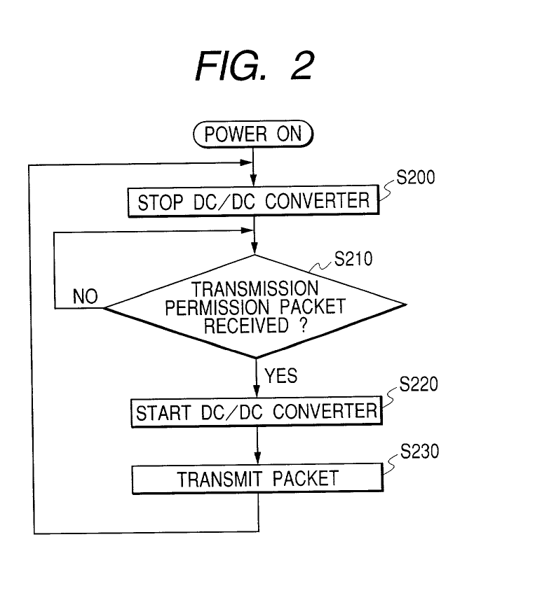

The wireless communication device 10 has a CPU 10C and a memory 1M. The flowchart of the CPU 10C configured to operate under the control of the CPU 10C is shown in FIG. 2. In this configuration, the wireless communication device 10 performs an operation described in the present embodiment under the control of the CPU 10. The memory IOM is a storing medium for storing a program so as to be read out by the CPU 10C. The CPU 10C is a computer that reads the program from the memory 10M and operates. In the configuration that this program is stored in a floppy disk, a CD-ROM or the like (not shown) and the CPU 10C reads out the program through a floppy disk driver or a CD-ROM driver provided in the wireless communication device 10, the floppy disk or the CD-ROM in which the program is stored corresponds to the storing medium for storing the program so as to be read out by the CPU 10C. Further, the program may be externally supplied to the CPU 10C through the antenna 11.

In this connection, the wireless communication device 10 does not need to include the CPU and the memory. A logic circuit may be formed instead thereof so that a similar control can be realized.

The wireless communication device 10 divides image information supplied from an image information device 20 to form packets and transmits the obtained packets to a wireless network (an illustration is omitted). To the wireless network, a printer (an illustration is omitted) having the wireless communication device is connected. The wireless communication device of the printer serves as a master device and periodically transmits a transmission permission packet to the wireless communication device 10 serving as a slave device.

When the power switch 2 is turned on, the voltage of the battery 1 is applied to the series regulator 3 and the DC/DC converter 4. As a result, the series regulator 3 supplies the stabilizing output voltage to the wireless communication device 10, so that the wireless communication device 10 operates to be in a receiving state. The series regulator 3 is set so as to supply an amount of electric current required by the wireless communication device 10 at the time of receiving the image information to the wireless communication device 10. Since the wireless communication device 10 is brought to a receiving state under a state that the power switch 2 is turned on, the state signal of a low level is sent to the DC/DC converter 4 from the wireless communication device 10 (step S200). Thus, the DC/DC converter 4 does not operate.

When the wireless communication device 10 under the receiving state receives a transmission permission packet through the wireless network from the wireless communication device of the printer serving as the master device (step S210), the wireless communication device 10 moves to a transmission state in order to transmit a response packet to the wireless communication device 10 of the printer. Thus, the state signal of a high level is transmitted to the DC/DC converter 4 through the signal line 12 from the wireless communication device 10 (step S220) to start the DC/DC converter 4. Accordingly, an output current from the DC/DC converter 4 as well as an output current from the series regulator 3 is supplied to the wireless communication device 10. The DC/DC converter 4 is set so that the total amount of current of both the output current is equal to an amount of current required when the wireless communication device 10 transmits the image information.

In the case where the image information is transmitted, an operator selects an image to be transmitted by a key switch (not shown) of the wireless communication device 10 and sets a device of a transmission destination or the like, and then, instructs a transmission of the image information, the wireless communication device 10 divides into packets the image information to which the addresses of the transmission destinations and the numbers of packets, etc. are added in synchronization with the transmission permission packets periodically sent from the wireless communication device of the printer and transmits the packets to the wireless communication device of the printer (step S230). The printer that receives the packets performs a printing operation on the basis of the received image information.

When the transmission of the packets is completed, the wireless communication device 10 returns to the step S200 to send the state signal of a low level from the wireless communication device 10 to the DC/DC converter 4 and to stop the DC/DC converter 4.

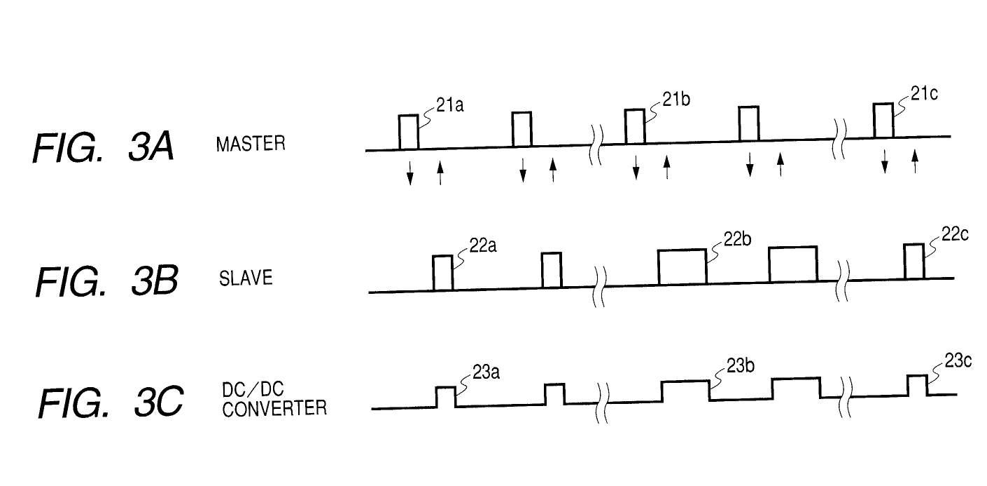

FIGS. 3A to 3C are timing charts showing the transmission timing of transmission permission packets and transmission packets in the wireless communication device 10 and the operation timing of the DC/DC converter 4.

(A) shows the transmission timing of the transmission permission packets transmitted to the wireless communication device 10 from the wireless communication device of the printer serving as the master device. (B) shows the transmission timing of the transmission packets to be transmitted to the wireless communication device of the printer by the wireless communication device 10 serving as the slave device. (C) shows the operation timing of the DC/DC converter 4 operates.

When the wireless communication device of the printer as the master device transmits the transmission permission packet 21a to the wireless communication device 10, the wireless communication device 10 as the slave device transmits the transmission packet 22a responding to the transmission permission packet 21a to the wireless communication device of the printer. When the wireless communication device of the printer receives this transmission packet 22a, the wireless communication device of the printer recognizes that the connection of the wireless network is established. Only during a period 23a corresponding to a period during which the wireless communication device 10 transmits the transmission packet 22a, the DC/DC converter 4 operates. Accordingly, in the period that the wireless communication device 10 is not brought to a transmission state (a period of receiving state), the power consumption of the DC/DC converter 4 is not generated.

The transmission permission packets are periodically transmitted to the wireless communication device 10 from the wireless communication device. The wireless communication device 10 responds to these transmission permission packets and usually returns the transmission packets to the wireless communication device of the printer.

A transmission packet 22b designates a transmission packet when the wireless communication device 10 transmits the image information to the wireless communication device of the printer. For instance, when the transmission of an image is instructed before a transmission permission packet 21b is received, the transmission packet 22b is transmitted to the wireless communication device of the printer in synchronization with the transmission permission packet 21b. Since the image information is added to the transmission packet 22b, a transmission time is extended. The DC/DC converter 4 also operates throughout a period 23b with the extension of the transmission time of the transmission packet 22b. After the image information is transmitted, the wireless communication device 10 responds to a transmission permission packet 21c in the same manner as that before the image information is transmitted to return a transmission packet 22c to the wireless communication device of the printer, so that a wireless network connection environment is maintained.

As described above, according to the first embodiment, the DC/DC converter 4 operates every time the wireless communication device 10 transmits a transmission packet to supply a power required for the transmission to the wireless communication device 10, and the operation of the DC/DC converter 4 is stopped at any time other than the transmission. Thus, the power consumption in the DC/DC converter 4 is prevented during the time except the transmission.

Further, in the above description, although the signal line 12 serves to transmit the state signal showing the transmission state of the wireless communication device 10 to the DC/DC converter 4, it is to be understood that a signal indicating the state transition of transmission may be used. That is, there may be employed a signal that reaches a high level immediately before the wireless communication device 10 moves from a transmission stop state to a transmission state and reaches a low level after the wireless communication device moves from the transmission state to the transmission stop state. In this embodiment, the DC/DC converter 4 can be started prior to the transmission by the wireless communication device 10. Accordingly, the start time of the DC/DC converter 4 can be easily designed and the capacity of a capacitor for suppressing the voltage fluctuation at the time of switching a power circuit can be reduced.

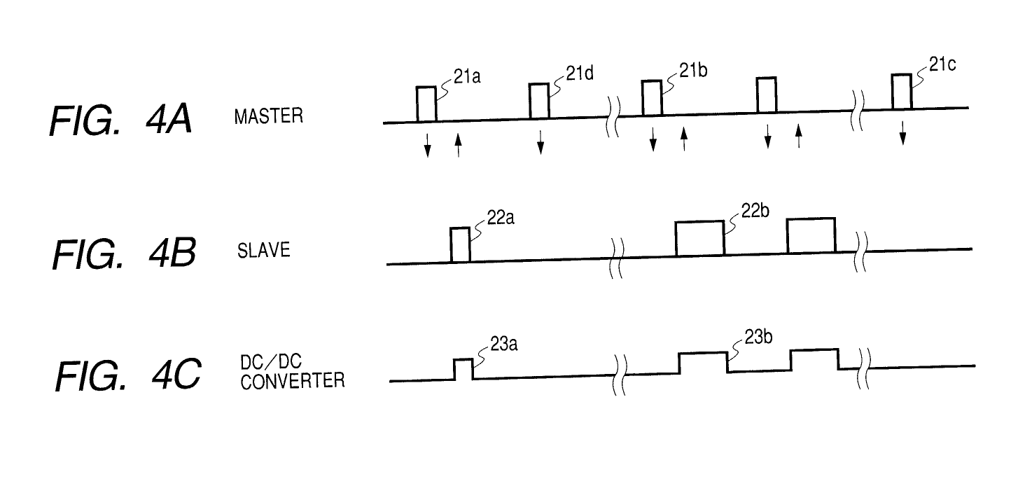

The present invention may be operated in a manner illustrated in a timing chart shown in FIGS. 4A to 4C.

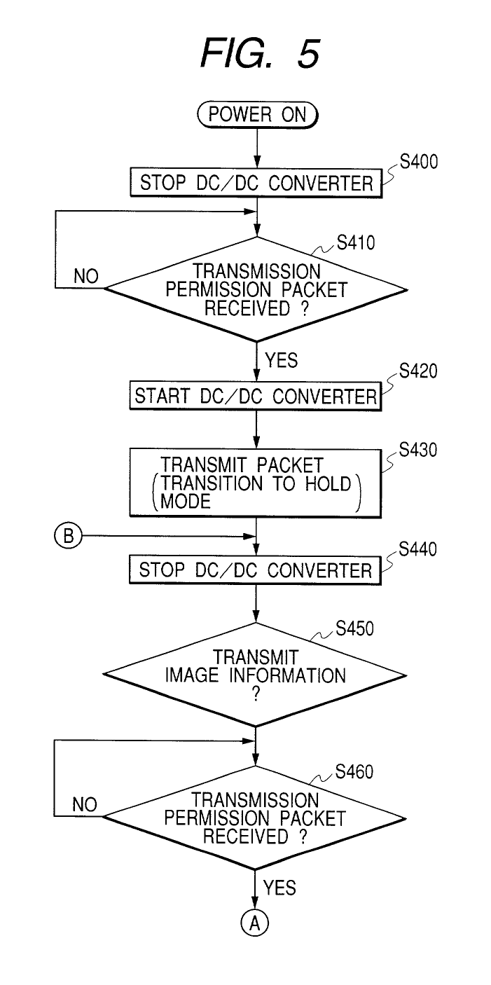

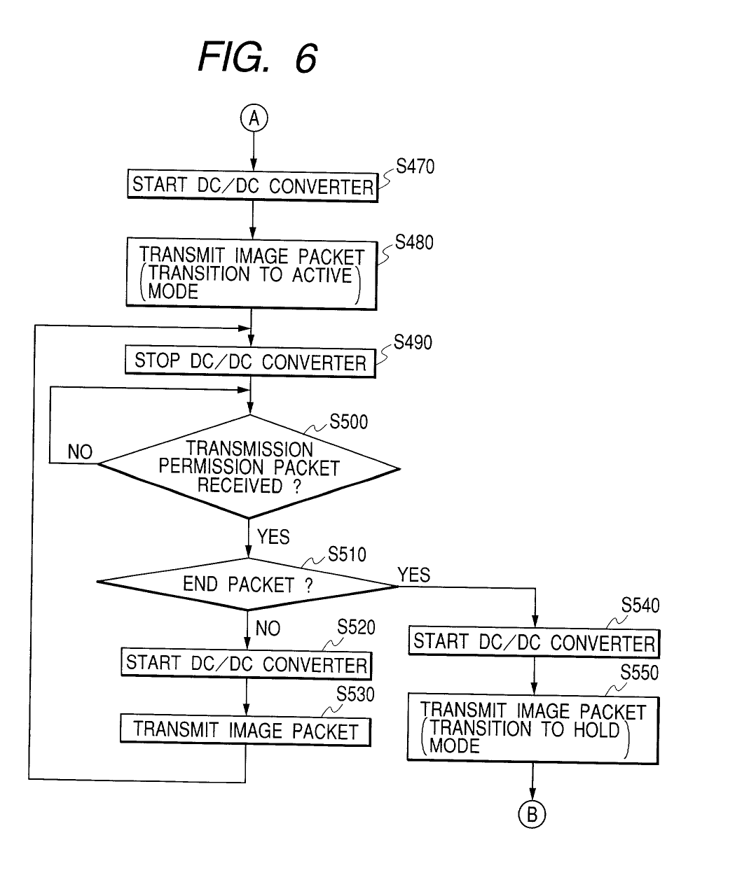

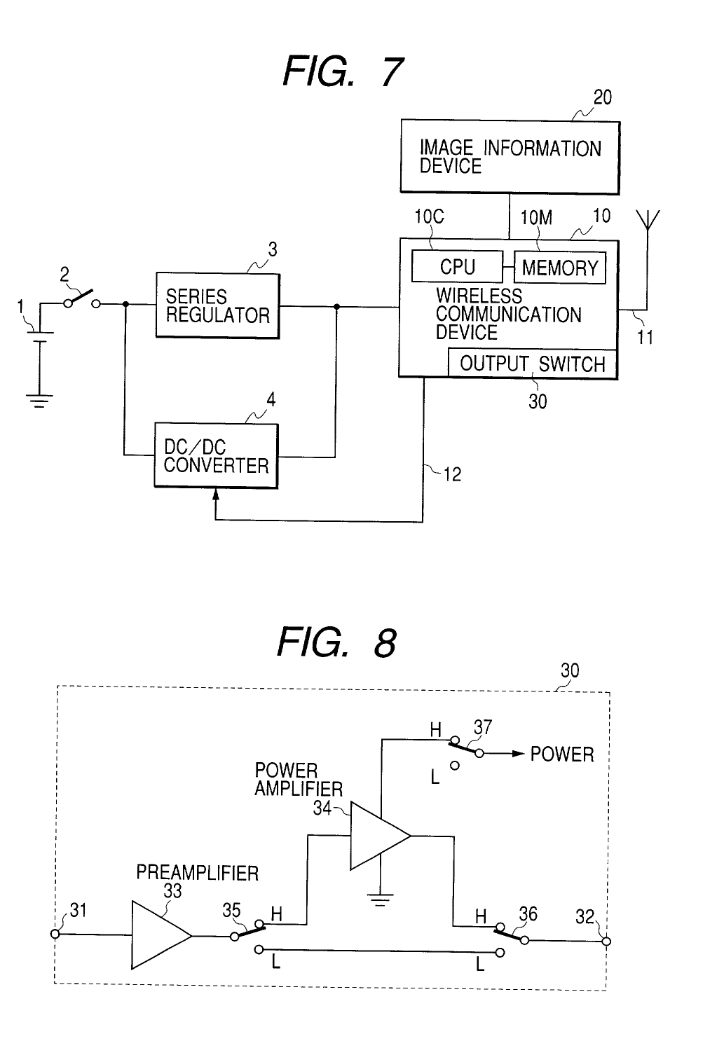

Next, since a configuration for realizing the timing chart shown in FIGS. 4A to 4C is basically the same as that of the first embodiment shown in FIG. 1, the configuration of the first embodiment will be employed in the description of the second embodiment. In the second embodiment, a communication device 10 operates in accordance with flowcharts shown in FIGS. 5 and 6 in place of the flowchart shown in FIG. 2.

FIGS. 4A to 4C are timing charts showing the transmission timing of transmission permission packets and transmission packets and the operation timing of a DC/DC converter 4 in the second embodiment. In FIGS. 4A to 4C, parts the same as those in the timing chart of the first embodiment shown in FIGS. 3A to 3C are denoted by the same reference numerals.

When a power switch 2 is turned on, the voltage of the battery 1 is applied to a series regulator 3 and a DC/DC converter 4. As a result, the series regulator 3 supplies stabilizing output voltage to the wireless communication device 10. The wireless communication device 10 operates to be brought to a receiving state and set to an active mode. The series regulator 3 is set so that an amount of electric current required for the wireless communication device 10 at the time of a receiving state is supplied to the wireless communication device 10. Here, since the wireless communication device 10 is brought to a receiving state, the state signal of a low level is transmitted to the DC/DC converter 4 from the wireless communication device 10 so that the DC/DC converter 4 does not operate (step S400).

When the wireless communication device 10 located in the receiving state receives a transmission permission packet 21a through a wireless network from the wireless communication device of a printer serving as a master device (step S410), the wireless communication device 10 shifts to a transmission state in order to transmit a transmission packet 22a responding thereto to the wireless communication device of the printer. Thereby, the state signal of a high level is transmitted to the DC/DC converter 4 from the wireless communication device 10 (step S420) to start the DC/DC converter 4. Accordingly, not only output current from the series regulator 3, but also output current from the DC/DC converter 4 is supplied to the wireless communication device 10. Thus, the DC/DC converter 4 is set so that the total amount of electric current of both the output current is equivalent to an amount of electric current required for the wireless communication device 10 at the time of a transmissing operation. Only during a period 23a corresponding to a period during which the wireless communication device 10 transmits the transmission packet 22a, the DC/DC converter 4 operates.

To the above described transmission packet 22a, is added information that the wireless communication device 10 shifts from the active mode to a hold mode (step S430). The wireless communication device of the printer receiving the transmission packet 22a recognizes that the wireless communication device 10 shifts to the hold mode. When the transmission of the packet is completed, the state signal of a low level is transmitted to the DC/DC converter 4 from the wireless communication device 10 to stop the DC/DC converter 4 (step S440).

The wireless communication device of the printer which recognizes the transition to the hold mode of the wireless communication device 10 does not perform an error processing such as a request for twice transmission even when the wireless communication device 10 has no response to a transmission permission packet 21d transmitted next to maintain a wireless network connection environment. Then, the transmission permission packets are periodically transmitted to the wireless communication device 10.

Like this, since the wireless communication device 10 which shifts to the hold mode as described above does not need to return transmission packets responding to the transmission permission packets, the wireless communication device 10 does not enter a transmission state. Accordingly, the DC/DC converter 4 does not operate and a power consumption by the DC/DC converter 4 is not generated during this time. Further, in the hold mode, a receiving circuit in the wireless communication device 10 is stopped so that a power is saved more than that during a receiving operation in the active mode.

In the case where the wireless communication device 10 transmits image information (step S450), the DC/DC converter 4 is started (step S470) synchronously with, for example, a transmission permission packet 21b (step S460) and a transmission packet 22b is transmitted to the wireless communication device of the printer (step S480). To the transmission packet 22b, is added information that notifies the transition from the hold mode to the active mode as well as the image information. The wireless communication device of the printer which receives the information about the transition to the active mode performs an error processing for sending a request for another transmission to the wireless communication device 10 by considering the generation of an error when there is no response to the transmission permission packet.

In a period 23b during which the wireless communication device 10 transmits the transmission packet 22b to the wireless communication device of the printer, the DC/DC converter 4 operates to supply a power at the time of transmission to the wireless communication device 10. When the transmission of the packets is completed, the state signal of a low level is sent to the DC/DC converter 4 from the wireless communication device 10 to stop the DC/DC converter 4 (step S490).

Further, when the wireless communication device 10 receives a transmission permission packet (step S500), if a packet to be transmitted is not equal to the last packet of image information to be transmitted (step S510), the wireless communication device 10 will start the DC/DC converter 4 (step S520) to transmit an image packet (step S530).

When the transmission packet is a transmission packet for transmitting the last part of the image information to be transmitted, the wireless communication device 10 starts the DC/DC converter 4 (step S540) to add the information of the transition to the hold mold to the transmission packet and send that transmission packet to the wireless communication device of the printer (step S550) and shifts to the hold mode. Thus, the DC/DC converter 4 does not operate again, nor the power consumption is generated in the DC/DC converter 4.

In the second embodiment, although a mode changing notification for moving the hold mode to the active mode, or moving the mode to an opposite direction thereto is added to a packet for transmitting the image information before and after the image information is transmitted, it is to be understood that the mode changing notification may be carried out by using an independent packet different from the packet for transmitting the image information.

In the above described embodiment, although the DC/DC converter 4 is operated only when the wireless communication device 10 is located in a transmission state, it is to be noted that the DC/DC converter 4 may be operated only when the wireless communication device 10 is brought to a transmission state at a prescribed output level or higher. Therefore, when the wireless communication device 10 is located in a receiving state or a transmission state at an output level lower than a prescribed output level and the state signal is located at a low level, a power consumption is not generated in the DC/DC converter 4. This fact will be described below by referring to FIG. 7.

In a third embodiment, a transmission output switching circuit 30 is provided in a wireless communication device 10.

In FIG. 7, when the wireless communication device 10 located in a receiving state receives a transmission permission packet through a wireless network from the wireless communication device of a printer serving as a master device, the wireless communication device shifts to a transmission state in order to transmit a response packet to the wireless communication device of the printer.

At this time, a transmission output is set to the transmission of a high output at a prescribed transmission level or higher in the transmission output switching circuit 30, the state signal of a high level is transmitted to a DC/DC converter 4 through a signal line 12 from the wireless communication device 10 to start the DC/DC converter 4. Accordingly, an output current from the DC/DC converter 4 in addition to output current from a series regulator 3 is supplied to the wireless communication device 10. The DC/DC converter 4 is set so that the total amount of electric current of both the output current is an amount of electric current required at the time of a high output transmission by the wireless communication device 10.

In the case where the consumed power of the wireless communication device 10 during a transmitting operation is set to a low transmission output lower than a prescribed transmission output, the consumed power of the wireless communication device 10 during the transmitting operation is not greatly changed from that during a receiving operation and the power from the series regulator 3 is desirably supplied, so that the DC/DC converter 4 is not driven even during the transmission.

In the third embodiment, when the transmission output is set to a high transmission output in the output switching circuit 30, an operation is carried out in the same manner as that shown in FIGS. 2 and 3A to 3C. That is, in the flowchart shown in FIG. 2, when a transmission permission packet is received in step S 210, if the transmission output is set to a high transmission output, the procedure advances to step S220 under the control of the CPU to drive the DC/DC converter 4. On the other hand, when the transmission permission packet is received in step S210, if the transmission output is set to a low transmission output, the procedure does not advance to the step S220 to keep the DC/DC converter 4 stopped.

The high transmission output and the low transmission output may be manually switched, or may be switched in accordance with a receiving strength in the wireless communication device 10 by judging a distance between the wireless communication device of the printer and the wireless communication device 10 on the basis of the receiving strength.

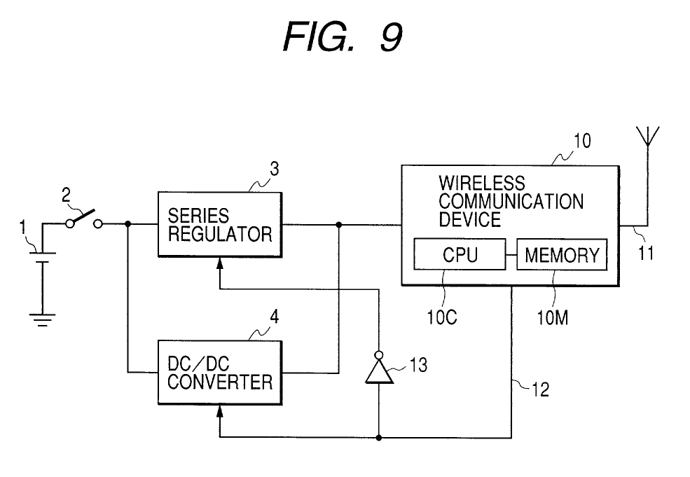

As one example for switching the transmission output, the configuration of the transmission output switching circuit 30 will be illustrated in FIG. 8.

The transmission output switching circuit 30 comprises an input terminal 31, an output terminal 32, a preamplifier 33, a power amplifier 34, switches 35 and 36 and a disconnection switch 37.

When a transmission signal is inputted to the input terminal 31, it is amplified to a prescribed low transmission output level by the preamplifier 33. When the switches 35 and 36 are set to H, the transmission signal amplified to the low transmission output level is further amplified to a prescribed high transmission output level by the power amplifier 34 and the transmission signal amplified to the high transmission output level is outputted from an antenna 11 through an antenna switch (not shown) from the output terminal 32. At this time, the disconnection switch 37 is set to H so that power is supplied to the power amplifier 34.

When the switches 35 and 36 are set to L, a transmission signal of a low transmission output level amplified by the preamplifier 33 is outputted from an antenna 11 through the antenna switch (not shown) from the output terminal 32. In this case, the disconnection switch 37 is set to L to stop the operation of the power amplifier 34. Accordingly, the cost of wasteful power consumption of the power amplifier 34 can be reduced.

In the above described embodiments, although the series regulator 3 always operates irrespective of the transmission and receiving states, it is to be understood that the series regulator 3 may be operated only during the receiving operation and only the DC/DC converter 4 may be operated during the transmitting operation in place thereof. A fourth embodiment for realizing the above described operation will be described below by referring to FIG. 9.

FIG. 9 is a block diagram showing a power circuit of a wireless communication device in which a series regulator 3 is operated only at the time of a receiving operation. Since the configuration of the power circuit shown in FIG. 9 is basically the same as that shown in FIG. 1, the same parts as those in FIG. 1 are denoted by the same reference numerals and the explanation thereof will be omitted.

In the power circuit shown in FIG. 9, an inverter 13 is disposed between a signal line 12 and a series regulator 3. The series regulator 3 operates only when a high level signal is inputted thereto from the inverter 13.

As described by referring to FIG. 1, when the wireless communication device 10 is brought to a receiving state, the state signal of the signal line 12 is located in a low level, so that a high level signal is inputted to the series regulator 3 from the inverter 13 to operate the series regulator 3. On the other hand, a low level signal is inputted to a DC/DC converter 4 from the signal line 12 so that the DC/DC converter 4 is not operated. On the contrary, when the wireless communication device 10 is brought to a transmission state, the state signal of the signal line 12 is located in a high level. Thus, a low level signal is inputted to the series regulator 3 from the inverter 13 so that the series regulator 3 does not operate. On the other hand, a high level signal is inputted to the DC/DC converter 4 from the signal line 12 to operate the DC/DC converter 4. In such a way, the series regulator 3 operates only during the receiving operation and only the DC/DC converter 4 operates during the transmitting operation.

An explanation will be given below with reference to the flowchart shown in FIG. 2. In step S200, the series regulator 3 is driven and the DC/DC converter 4 is stopped. Further, in step S220, the series regulator 3 is stopped and the DC/DC converter 4 is driven.

In the above described embodiment, although the signal of the signal line 12 is inverted to control the series regulator 3, it is to be understood that modifications as mentioned below may be performed.

That is, a control signal exclusively used for the series regulator 3 is employed, and when the DC/DC converter 4 is started, the series regulator 3 is stopped with a slight delay of the driving of the DC/DC converter 4. Further, when the DC/DC converter 4 is stopped, the series regulator 3 is driven before the DC/DC converter 4 is stopped, and then, the DC/DC converter 4 is stopped.

Further, in the above embodiments, although the series regulator is described as an example of a power circuit small in its current supply capacity and the DC/DC converter is described as an example of a power circuit large in its current supply capacity, it is to be recognized that both the power circuits may be formed by the DC/DC converters in place thereof. Still further, both the power circuits may be formed by other power circuit such as a switched capacitor or the like. Still further, two or more power circuits may be provided.

Further, in the above described embodiments, although the battery is used as a power supply source, the voltage stabilizing circuit can be effectively utilized so that a power loss can be prevented in the voltage stabilizing circuit itself in the present invention. It is to be understood that the power supply source is not limited to the battery and a power may be supplied by an AC adapter from a commercial power source.

Additionally, in each of the above described embodiments, although the image information is transferred to the wireless communication device of the printer from the wireless communication device included in the image information device as an example, it is to be understood that the present invention may be generally applied to a configuration that one wireless communication device intermittently transfers information to the other wireless communication device. Although the present invention is described on the basis of the preferred embodiments, it is to be understood that the present invention is not limited to these embodiments.

That is, an OS or the like operating on a computer may perform a part or all of the actual processes and the functions of each of the above embodiments may be realized by the above processes.

Furthermore, after a program code read from a storing medium is written in a memory provided in a function expansion board inserted into a computer or a function expansion unit connected to the computer, a CPU or the like provided in the function expansion board or the function expansion unit may execute a part or all of the actual processes on the basis of the instruction of the program code so as to realize the functions of each of the embodiments in accordance with the processes.

What is claimed is:

1. A wireless communication device, comprising:
wireless communicating means;
a plurality of voltage stabilizing means; and
control means for controlling the plurality of voltage stabilizing means in association with a transmission from said wireless communicating means,
wherein said plurality of voltage stabilizing means stabilize the output voltage of a common power source and supply the stabilized output voltage to the wireless communicating means.

2. The wireless communication device according to claim 1, wherein said control means stops one of the plurality of voltage stabilizing means in association with the transmission from said wireless communicating means.

3. The wireless communication device according to claim 1, wherein said control means stops one of said plurality of voltage stabilizing means while the transmission is not permitted.

4. The wireless communication device according to claim 1, wherein said control means stops one of said plurality of voltage stabilizing means after the transmission from said wireless communicating means.

5. The wireless communication device according to claim 1, wherein said control means switches one of said plurality of voltage stabilizing means for supplying voltage to said wireless communicating means in association with the transmission from said wireless communicating means.

6. The wireless communication device according to claim 1, wherein said plurality of voltage stabilizing means include a series regulator and a DC/DC converter.

7. A wireless communication device, comprising:
wireless communicating means;
first and second supply means for supplying a power to said wireless communicating means; and
control means for supplying the power from both the first and second supply means to the wireless communicating means in a transmission state and supplying a power to the wireless communicating means in a receiving state from one of said first and second supply means.

8. A wireless communication device, comprising:
wireless communicating means having a first mode for transmitting a response signal to a signal from a communication partner and a second mode for transmitting no response signal to the signal from the communication partner;
a plurality of power supply means; and
control means for controlling said plurality of power supply means in accordance with the transmission from said wireless communicating means,
wherein said wireless communicating means transmits a first signal showing the first mode and a second signal showing the second mode to the communication partner.

9. The wireless communication device according to claim 8, wherein said wireless communicating means transmits the second signal in accordance with the start of the transmission of image information and transmits the first signal in accordance with the completion of the transmission of image information.

10. A wireless communication device, comprising:
wireless communicating means;
a plurality of power supply means; and
control means for controlling said plurality of power supply means in accordance with the transmission power of said wireless communicating means.

11. A wireless communication method, comprising the steps of:
stabilizing an output voltage of a common power source to generate a plurality of stabilized voltages; and
controlling the stabilized voltage supplied to a wireless communication part in accordance with the reception of a wireless signal from a communication partner.

12. The wireless communication method according to claim 11, wherein said control step stops one of the plurality of stabilized voltages in accordance with the reception in the receiving step.

13. The wireless communication method according to claim 11, wherein said control step switches one of the plurality of stabilized voltages to be supplied to the wireless communication part.

14. A wireless communication method, comprising the steps of:
supplying a power from both first and second power supply parts to a wireless communication part in a transmission state; and
supplying a power from one of the first and second power supply parts to the wireless communication part in a receiving state.

15. A wireless communication method, comprising the steps of:
controlling a plurality of power supply parts in association with a transmission from a wireless communication part;
transmitting to a communication partner a first signal showing a first mode for transmitting a response signal relative to a signal from the communication partner; and
transmitting to the communication partner a second signal indicating a second mode for transmitting no response signal relative to a signal from the communication partner.

16. The wireless communication method according to claim 15,
wherein the first signal is transmitted in accordance with the start of the supply of power in the first transmitting step, and
the second signal is transmitted in accordance with the start of the transmission of image information in the second transmitting step.

17. A wireless communication method, comprising the steps of:
setting the transmission power of a wireless communication part; and
controlling a plurality of power supply parts in accordance with the transmission power of said wireless communication part.
